(19) United States
(12) Patent Application Publication
(10) Pub. No.: US 2004/0222141 A1
(43) Pub. Date: Nov. 11, 2004

(54) Dental mercury abatement system

(76) Inventor: Buddy Don Gray, Dellrose, TN (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/467,734

(22) PCT Filed: Feb. 13, 2002
(86) PCT No.: PCT/US02/04744

Related U.S. Application Data
(60) Provisional application No. 60/268,727, filed on Feb. 13, 2001.

(51) Int. Cl. B03B 5/66; B01D 21/00

(52) U.S. Cl. 210/300; 209/158; 210/314; 210/323.1

(57) ABSTRACT

A system to remove mercury and mercury-containing particles from waste water prior to entrance into a municipal sewage system. In one form, the system includes a housing having an interior chamber with an inlet and outlet in fluid communication in the chamber, and a filter inside the chamber. The filter, in one embodiment, includes a course filter, an abatement filter, and an ion exchange filter. The chamber and filter may be formed in a removable cartridge mounted in the housing to facilitate safe handling and disposal thereof.

### BACKGROUND OF THE INVENTION

1. Field of the Invention

The present invention relates generally to a system for removing mercury from wastewater, and, more particularly, to a system that separates particulate such as mercury-bearing amalgam from water after use in dental procedures and to the disposal of the separated mercury-laden material after collection in the system.

2. Description of Prior Art

When an amalgam filling is removed from a patient's tooth, it is normally ground away by some sort of dental burr. This generates a multitude of amalgam particles that contain a large amount of mercury. These particles, and the mercury with them, are normally discharged into the sanitary sewer along with the water used to cool the dental burr and flush the particles out of the patient's mouth. The normal municipal waste treatment plant is not designed to remove mercury from wastewater, so therefore, mercury is discharged into the local streams and estuaries where it is adsorbed and ingested by the plants and animals within these bodies of water. When these plants and animals are consumed further up the food chain, higher life forms, including humans, become susceptible to mercury poisoning.

The presence of mercury in dental wastewater has been known since the inception of mercury-based amalgam. The problems associated with the increasing levels of mercury in estuaries connected to municipal waste water systems have also been known for many years. However, it has only been recently that the increasing level of mercury in the world's waters has been directly associated with dental wastewater. It is even more recent that any effort to stem these increasing mercury levels has been initiated. These efforts to eliminate mercury from dental wastewater streams and subsequently the natural water sources of the world include:

U.S. Pat. No. 5,795,159 (Ralls et al.), Aug. 18, 1998, where there is an initial gravity-dependent separation of the gaseous phase from the liquid and solid phase, followed by mechanical barrier-dependent separation of the liquid phase from the solid phase, which in turn is followed by a remixing of the gaseous phase with the liquid phase that is then wasted to drain. To dispose of the collected solid waste, the system is opened, the filter is either manually cleaned out or sealed up and replaced. This type of system is intended for multiple stations to feed into and to last for several days. While the device of Ralls et al. will separate the mercury-laden particles from the liquid and gaseous phases, it does not necessarily eliminate or reduce the mercury, but in fact it most likely will increase the amount of mercury dissolved in the wastewater. This lack of reduction and probable increase in dissolved mercury stems from the amount of time the water remains in contact with the mercury-laden particles trapped by the filter, which may not be changed for several days. With the particles remaining in water during the closed hours of the office, the mercury is more likely to go into solution in the water than if the filter is changed on a daily bases at the end of work hours.

There are numerous other devices that have been proposed to separate mercury from the dental waste stream; however, for the most part, their main purpose was the reclamation of metals rather than eliminating mercury pollution at the source. Most prior art devices allow mercury-laden particles to remain in water for extended periods of time. This allows the mercury to become dissolved into the water, malting abatement all the more difficult. For the most part, mercury that is dissolved into water is completely ignored by the mechanisms and processes of the prior art.

What these prior efforts have in common, other than removal of mercury-laden particles, is that mercury dissolved in water is not addressed, mercury vapor is not addressed, safe handling of the collected mercury-laden material is not addressed, and timely change out or cleaning of the system is not addressed.

Therefore, a need exists for an affordable, safe to handle, totally disposable system that will reduce the contact time of mercury-laden particles with water, reduce the amount of mercury vapor released to the air, allow for timely and simple replacement, and restore the confidence of the dental office worker that their exposure, their patient's exposure, and the environment's exposure to mercury is greatly reduced.

### BRIEF SUMMARY OF THE INVENTION

The disclosed and claimed embodiments of the invention are directed to a system that primarily removes mercury-laden particles from a dental waste stream. The embodiments of the present invention also have application in the removal of various other forms of mercury found in the solid, liquid, and gaseous phases. The system is preferably disposable, but may find application in a form where the consumables are changed without disposing of the housings and connections. While the embodiments of the invention are configured to reduce the amount of mercury contamination finding its way into the natural waters, the utility of the invention is such that it will also provide a safer atmosphere in the immediate dental office.

In one embodiment, a system for filtering mercury and mercury-laden particles is provided that includes a housing having an internal chamber, an inlet in fluid communication with the chamber, and a filter in the chamber. In accordance with an aspect of this embodiment, the filter includes a course filter, an abatement filter, and an ion exchange filter. In accordance with another aspect of this embodiment, the filter includes a course screen, an abatement filter, such as a carbon block, and a disinfectant filter, each separated by a space in the chamber.

In another embodiment, the chamber is formed inside a cartridge that is removably mounted inside the housing to facilitate disposal of the filtered material.

### BRIEF DESCRIPTION OF THE SEVERAL VIEWS OF THE DRAWING(S)

The features and advantages of the present invention will be more readily appreciated as the same become better understood from the following detailed description when taken in conjunction with the accompanying drawings, wherein like numbers designate like elements, and wherein:

FIG. 1 is a cross-sectional illustration of one embodiment of the system with standard hose-barb type connections and simplified media configuration.

FIG. 2 is a cross-sectional illustration of another embodiment of the invention with quick-disconnect type connections and complex media configuration.

FIG. 3 is a cross-sectional illustration of an alternative embodiment of the invention that will allow quick, easy, and safe change-out of the media and trapped mercury without disposal of the overall housing and connecting elements.

### DETAILED DESCRIPTION OF THE INVENTION

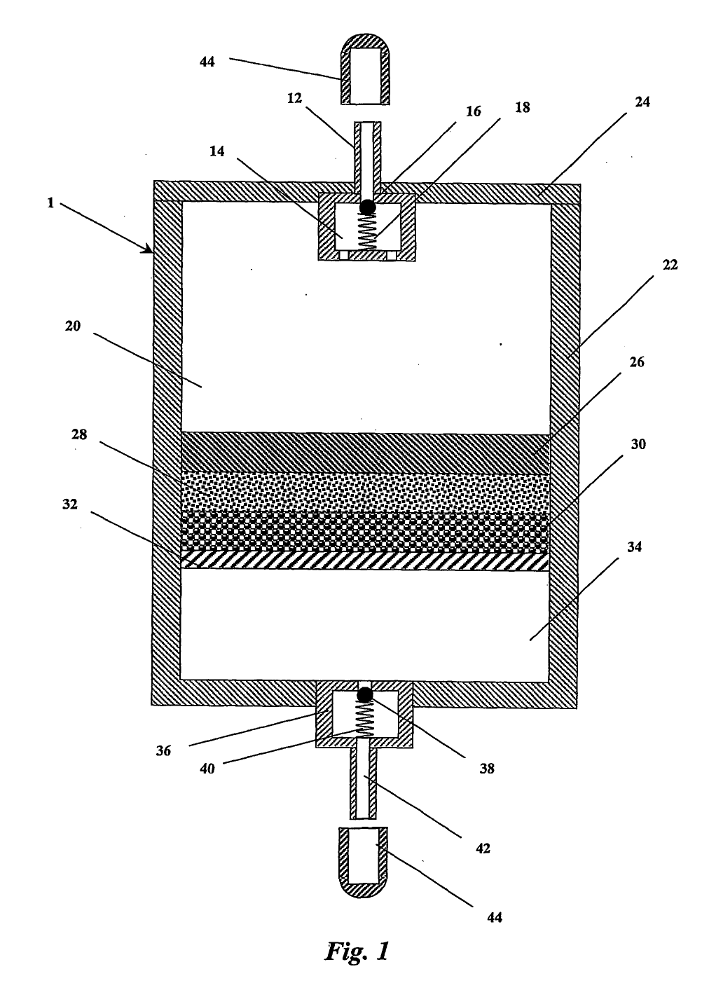

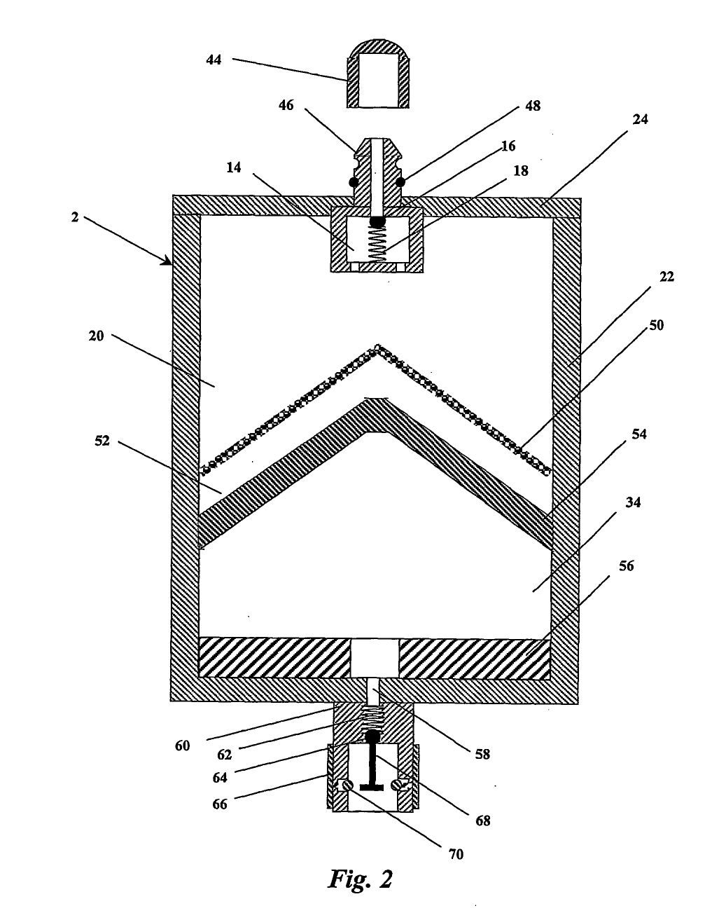

Referring to FIGS. 1 and 2, there is shown preferred embodiments of a mercury abatement device 1 with standard hose barb type fittings and a mercury abatement device 2 with quick disconnect fittings, both of which are totally disposable. In normal operation, with an external vacuum source (not shown) supplying the motive force, the dental debris, including mercury-laden particles, which are generated by grinding, shaping, filling, or other operation, liquids such as bodily fluids and water used to cool grinding tools and to flush out debris, and air, are picked up by the dental aspiration hand piece (not shown), or other type instrument (not shown), fed through flexible tubing (not shown), through the inlet hose barb fitting 12 for the device 1 or through an inlet quick disconnect fitting 46, which latches to the mating fitting (not shown) and which is sealed by an inlet quick disconnect O-ring 48 for the device 2, and pass through an inlet check valve assembly 14.

An inlet check valve ball seal 16, which is normally held in the closed position by an inlet check valve spring 18, opens due to the force of the vacuum and its resulting flow, allowing the mixed phase flow of solids, liquids, and gases to enter an inlet chamber 20, which is formed by a canister housing 22, the canister end closure 24, and the particulate filter media 26 in FIG. 1 or a coarse separation screen 50 in FIG. 2.

In FIG. 1, the bulk of the solid phase portion of the flow is trapped by a media 26, which allows only those particles smaller than the pore size of the media 26, the liquids, and the gases to pass through. In one embodiment the media 26 is a course particle screen or particulate filter known in the art. The next encounter is with a first abatement media 28, which is preferably an activated carbon block, but may be of other suitable material, which should trap any solid particles that pass through the particulate filter media 26, thus resulting substantially in only a liquid and gaseous phase flow, and also which will absorb the bulk of the dissolved and gaseous mercury which has gone into solution in the liquids or mixed with the other gases. The next encounter is with the second abatement media 30, which is preferably an ion exchange material that will further reduce the amount of mercury in the continuing flow of liquids and gases. A filter material support 32 serves to keep the filter and abatement media from adding to the flow as it passes through the device.

In FIG. 2 a system is depicted in which the bulk of the solid phase is removed from the flow by a coarse separation screen 50, which allows the particulate matter to migrate to the lower portions of the inlet chamber 20. The conical shape of screen 50, shown as a triangular shape in the cross-sectional view of FIG. 2, and the void created by a coarse particle buffer space 52 cooperate to provide a less impeded flow for the liquid and gaseous phases. This results in less contact time of the liquids and gases with the mercury-laden solids, thus resulting in less mercury being picked up and mixed or dissolved into the flow, resulting in less work for the subsequent abatement medias.

The function of an additional filtration/abatement media 54 is identical to that of the medias 28 and 30 and the support 32 shown in FIG. 1. It should be noted that the media and screen configuration of FIG. 2 and that of FIG. 1 may be interchanged or intermixed, or may be in the form of a mixed media rather than stratified, to provide an optimum configuration.

The next portion of the device to be encountered is the outlet chamber 34, which provides a place for the liquid and gaseous phase, that have been stripped of solid phase debris and dissolved and entrained mercury to quickly exit the filtration media, thus again reducing contact time with mercury-containing substances, and resulting in less mercury dissolved in the water. In FIG. 2, the next encounter is with a disinfection media 56, which, being in the form of oxidant available in dry or other form which can be somewhat uniformly dissolved or eroded by the water stream, will provide a means of disinfecting the water stream that could be contaminated with a multitude of viruses, bacteria, or other microbial contaminants emanating from the patient.

Next, again as shown in FIG. 2, the liquid and gaseous phases flow through an outlet passage 58. It should be noted that the disinfection media 56 and a passage 58 could work together or separately in the embodiment shown in FIG. 1.

Finally, in FIG. 1, the flow enters the outlet check valve assembly 36, where the outlet check valve ball seal 38 depresses the outlet check valve spring 40, due to the force of the vacuum and flow, and exits through the outlet hose barb fitting 42, which is connected to a tubing (not shown) which is itself connected to a vacuum source (not shown), a liquid/gaseous phase separation mechanism (not shown), and subsequent sewage drain (not shown).

In FIG. 2, after exiting the passage 58, the flow enters the outlet quick disconnect fitting 60, which when connected to a mating fitting (not shown), which is subsequently connected to the sewage drain as described for FIG. 1, causes an outlet quick disconnect actuator 68 to depress an outlet quick disconnect ball seal 64 against an outlet quick disconnect spring 62. This allows the flow to pass through the disconnect 60 into the mating fitting (not shown), which is held in place by outlet quick disconnect locking balls 70, which are either held in place or released to allow disconnection by the outlet quick disconnect release sleeve 66.

Prior to and after use, a connection seal cap 44 is placed over the fittings 12, 42, and 46. Since the disconnect fitting 60 is shown as a female, self-sealing type of fitting, it would not normally require a seal cap; however, it is envisioned that a non-sealing type fitting could be appropriate, in which case a male sealing plug (not shown) would be in order.

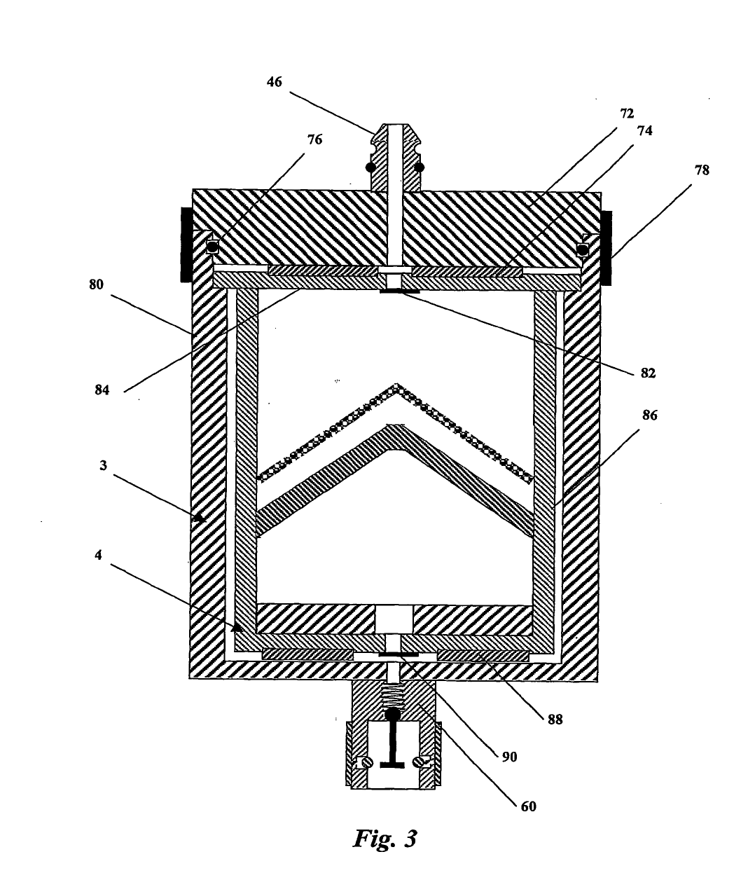

FIG. 3 shows an alternative embodiment, which consists of a mercury abatement device housing 3 and a mercury abatement device disposable cartridge 4. In this embodiment, the flow enters through the fitting 46 and flows through a passage in an outer housing top 72, which is sealed to an outer housing bottom 80 by an outer housing O-ring seal 76 and is held in place by an outer housing latch mechanism 78, which may be of any type of suitable mechanism such as toggle latches, threads, bayonets, etc. The top 72 is sealed to the cartridge 4 by the housing-to-cartridge top seal 74, which can be of any suitable type of compression seal. It is sandwiched between the top 72 and the cartridge top 84. The flow continues through a passage in the top 84 and through the cartridge inlet check valve 82, which is shown as a reed type valve, but may be of the type shown on FIG. 2 or any other suitable type check valve. The flow and processes through the remainder of the cartridge 4 and the housing 3 are identical to those for FIGS. 1 and 2 with the exception of the cartridge outlet check valve 90, which may be identical to the valve 82, and the housing-to-cartridge bottom seal 88, which in turn may be identical to the seal 74 and is sandwiched between the cartridge bottom 86 and the housing bottom 80.

The top 84 is shown as forming a keying mechanism to ensure proper installation of the cartridge 4; however, numerous other types of keying mechanisms would be appropriate.

While the principles of the invention have now been described in connection with the illustrated embodiments, there will be immediately obvious to anyone skilled in the art, many modifications of structure, arrangements, proportions, combinations, the elements, materials and components used in the practice of the invention and otherwise, which are particularly adapted for specific environments and operation requirements without departing from those principles. Such modifications are intended to come within the scope of the claims that follow and the equivalents thereof.

What is claimed is:

1. A device for abating the amount of dissolved and entrained contaminants in a stream of waste water, comprising:
an inlet fitting,
a housing,
contaminant abatement media and configured to filter at least mercury and mercury-laden matter,
an outlet fitting.

2. The device of claim 1 wherein said contaminant abatement media consists of a particulate filtration means.

3. The device of claim 1 wherein said contaminant abatement media consists of a particulate filtration means followed by one or more additional contaminant abatement means.

4. The device of claim 3 wherein said additional contaminant abatement media consists of one or more contaminant absorption means.

5. The device of claim 3 wherein said additional contaminant abatement media consists of one or more contaminant adsorption means.

6. The device of claim 3 wherein said additional contaminant abatement media consists of a combination of contaminant absorption and adsorption means.

7. The device of claim 3 wherein said particulate filtration means is followed by a buffer space that is configured to separate removed solid phase by a predetermined space from subsequent contaminant abatement means so as to lessen the amount of dissolved and non-dissolved contaminants exposed to said subsequent contaminant abatement means.

8. The device of claim 3 wherein said particulate filtration means and subsequent contamination means are in block form of one of either mixed and stratified beds.

9. The device of claim 3 wherein said additional contaminant abatement media are in one of either block form and particulate form of one of either mixed and stratified beds.

10. The device of claim 3 wherein said filtration and contaminant abatement means are shaped to have a first portion higher than a remaining portion.

11. The device of claim 3 wherein said additional contaminant abatement media includes a disinfection device.

12. The device of claim 1 further comprising accidental flow prevention device to prevent liquid leakage.

13. The device of claim 1 wherein said housing, fittings, and contaminant abatement media are configured as a singular disposable unit.

14. The device of claim 1 wherein said housing and fittings are configured as a separable two-part unit with the contaminant abatement media configured in a singular disposable unit for placement and use in a two-part unit.

15. The device of claim 1 wherein said inlet and outlet fittings are of a type that require no special mating fitting to connect to respective inlet and outlet tubing.

16. A system for filtering mercury and mercury-laden particles from wastewater that is transported via tubing, comprising:
a housing having an internal chamber, and an inlet and outlet in fluid communication with the chamber and configured to be coupled to the tubing; and
a filter in the chamber, the filter comprising a course filter, an abatement filter, and an ion exchange filter.

17. The system of claim 16, wherein the filter is configured so that wastewater entering the chamber first encounters the course filter.

18. The system of claim 16, wherein the course filter is configured to capture mercury-laden particles.

19. The system of claim 16, wherein the abatement filter comprises a carbon element.

20. The system of claim 16, further comprising at least one cap configured to cover one of either the inlet and the outlet to prevent leakage when not coupled to the tubing.

21. A mercury filter device for filtering mercury and mercury-laden materials from wastewater, comprising:
a housing configured to have an interior chamber, and an inlet and outlet in fluid communication with the chamber; and
a filter comprising a course separation screen, an abatement filter, and a disinfectant filter, the course separation screen and the abatement filter separated by a buffer space.

22. The device of claim 21, wherein the filter is mounted in the chamber so that wastewater entering the inlet of the housing first encounters the course separation screen.

23. The device of claim 22, wherein the course separation screen has a triangular cross-sectional configuration with an apex located adjacent the inlet.

24. A system for filtering mercury and mercury-laden particles from wastewater, the wastewater conveyed to the system via tubing, the system comprising:
a housing having a hollow interior, an outlet formed in one end of the housing and a removable top formed in an opposing end of the housing, the removable top having an inlet and outlet in fluid communication with the hollow interior;
a cartridge sized and shaped to be mounted within the housing, the cartridge having a chamber with an inlet and outlet configured to be in fluid communication with the inlet and outlet of the housing; and
a filter inside the chamber of the cartridge, the filter comprising a course particle screen and an abatement filter.

25. The system of claim 24, wherein the filter is configured to have the course particle screen located adjacent the inlet.

26. The system of claim 24, comprising a buffer space between the course particle screen and the abatement filter.

27. The system of claim 26 further comprising a disinfectant filter located in the chamber between the chamber outlet and the abatement filter.
